(19) United States
(12) Patent Application Publication
(10) Pub. No.: US 2026/0027982 A1
(43) Pub. Date: Jan. 29, 2026

(54) VEHICLE POWER MONITORING DEVICE, POWER MONITORING METHOD, AND COMPUTER PROGRAM

(71) Applicants: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP); TOYOTA JIDOSHA KABUSHIKI KAISHA, Toyota-shi (JP)

(72) Inventors: Yuki SANO, Yokkaichi-shi (JP); Yuta TANINAKA, Yokkaichi-shi (JP); Takuma YAMANE, Yokkaichi-shi (JP); Ryutaro YAMAZAKI, Toyota-shi (JP)

(73) Assignees: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP); TOYOTA JIDOSHA KABUSHIKI KAISHA, Toyota-shi (JP)

(21) Appl. No.: 19/278,946

(22) Filed: Jul. 24, 2025

(30) Foreign Application Priority Data
Jul. 26, 2024 (JP) 2024-120895

(51) Int. Cl. B60R 16/023; B60W 30/06

(52) U.S. Cl. CPC B60R 16/0231; B60R 16/0238; B60W 30/06; B60W 2510/305

(57) ABSTRACT

To monitor, for each service type, supply power from a power supply system and power consumptions of ECUs. A device according to one aspect of the present disclosure is a vehicle power monitoring device belonging to an in-vehicle communication system, and the device includes: an acquisition unit configured to acquire supply power from a power supply system, and power consumptions of a plurality of ECUs belonging to the in-vehicle communication system; and a processor configured to record the supply power and the power consumptions that have been acquired. The processor determines a service type being executed in a vehicle, and causes the acquisition unit to acquire the supply power and the power consumptions in the determined service type.

### CROSS-REFERENCE TO RELATED APPLICATIONS

This application claims priority of Japanese Patent Application No. JP 2024-120895 filed on Jul. 26, 2024, the contents of which are incorporated herein.

### TECHNICAL FIELD

The present disclosure relates to a vehicle power monitoring device, a power monitoring method, and a computer program.

### BACKGROUND ART

JP2010-254069 discloses a power supply control device including: a detection sensor for detecting a vehicle state; a determination unit for determining a target current consumption value of electronic control units (hereinafter referred to as “ECUs”) based on the detected vehicle state; a current sensor for detecting an actual current consumption value supplied from a battery to in-vehicle equipment; and a suppression unit for suppressing the operation of an ECU that is not necessary for the detected vehicle state, when the actual current consumption value exceeds the target current consumption value.

In JP2010-254069, as vehicle states, only stoppable states (shift position being other than R, vehicle speed being 50 km/h or more, and the like) of predetermined ECUs are defined, and it is not intended to monitor the supply power from the power supply system and the power consumption of each ECU for each service type, or monitor the same for the operation states of a plurality of ECUs.

The present disclosure has been made in view of the conventional problems described above and an object of the present disclosure is to realize monitoring of the supply power from the power supply system and the power consumption of each ECU, for each service type.

According to the power supply control device of JP2010-254069, since the target current consumption value of the ECUs is determined based on the vehicle state and the operation of the ECU not necessary for the vehicle state is suppressed, the current consumption of the ECUs can be suppressed before the remaining battery level is reduced.

Therefore, power consumption in an in-vehicle communication system can be more reliably suppressed, compared to the case of performing low power control based on the remaining battery level.

### SUMMARY

A device according to one aspect of the present disclosure is a vehicle power monitoring device, belonging to an in-vehicle communication system, which includes: an acquisition unit configured to acquire supply power from a power supply system, and power consumptions of a plurality of ECUs belonging to the in-vehicle communication system; and a processor configured to record the supply power and the power consumptions that have been acquired. The processor determines a service type being executed in a vehicle, and causes the acquisition unit to acquire the supply power and the power consumptions in the determined service type.

The present disclosure can be realized not only as an apparatus and a system having the characteristic configurations as described above, but also as a program for causing a computer to perform such characteristic configurations. In addition, the present disclosure can be realized as a semiconductor integrated circuit that realizes a part or the entirety of the apparatus and the system.

### Effects

According to the present disclosure, the supply power from the power supply system and the power consumption of each ECU can be monitored for each service type.

### BRIEF DESCRIPTION OF DRAWINGS

FIG. 1 is a network connection diagram showing an example of an overall configuration of an in-vehicle communication system and a power supply system installed in a vehicle.

FIG. 2 illustrates an example of a service type determination process.

FIG. 3 is a sequential diagram showing an example of a power monitoring process performed by a gateway device.

FIG. 4 illustrates a data table showing an example of monitoring data.

### DETAILED DESCRIPTION OF PREFERRED EMBODIMENTS

Hereinafter, the outline of an embodiment of the present disclosure is listed and described.

In a first aspect, a device according to one aspect of the present embodiment is a power monitoring device, belonging to an in-vehicle communication system, which includes: an acquisition unit configured to acquire supply power from a power supply system, and power consumptions of a plurality of ECUs belonging to the in-vehicle communication system; and a processor configured to record the supply power and the power consumptions that have been acquired. The processor determines a service type being executed in a vehicle, and causes the acquisition unit to acquire the supply power and the power consumptions in the determined service type.

According to the power monitoring device of the present embodiment, the processor determines the service type being executed in the vehicle, and causes the acquisition unit to acquire the supply power and the power consumption in the determined service type. Therefore, the supply power from the power supply system and the power consumption of each ECU can be monitored for each service type.

In a second aspect, in the power monitoring device according to the first aspect, the processor may collect the operation states of the plurality of ECUs in the determined service type, and record the collected operation states.

Thus, the operation states of the plurality of ECUs can be monitored for each service type as well.

In a third aspect, in the power monitoring device according to the first or the second aspect, the plurality of ECUs may include: a power-supply start-up ECU not having a network management function; and a communication start-up ECU having the function. In this case, in an in-vehicle communication network where the power-supply start-

up ECU and the communication start-up ECU coexist, the supply power from the power supply system and the power consumption of each ECU can be monitored for each service type.

In a fourth aspect, in the power monitoring device according to any one of the first to the third aspects, the service type may include at least one of: vehicle standby in which the vehicle is caused to stand by in a parked state so that the vehicle can always respond to a request of a user for a service; unmanned parking that is provided to the vehicle being unmanned and parked; manned parking that is provided to the vehicle being manned and parked; and manned traveling that is provided to the vehicle being manned and traveling.

In this case, the supply power from the power supply system and the power consumption of each ECU can be monitored for at least one of the vehicle standby, the unmanned parking, the manned parking, and the manned traveling.

In a fifth aspect, a method according to one aspect of the present embodiment is a power monitoring method performed by the power monitoring device according to any one of the first to the fourth aspects. Therefore, the power monitoring method of the present embodiment achieves the same functions and effects as those of the power monitoring device according to the first to the fourth aspects.

In a sixth aspect, a computer program according to one aspect of the present embodiment is a computer program that causes a computer to function as any one of the power monitoring devices according to the first to the fourth aspects. Therefore, the computer program of the present embodiment achieves the same functions and effects as those of the power monitoring device according to the first to the fourth aspects.

Hereinafter, details of an embodiment of the present disclosure will be described with reference to the drawings. At least parts of the embodiment described below may be combined as desired.

### Overall Configuration of System

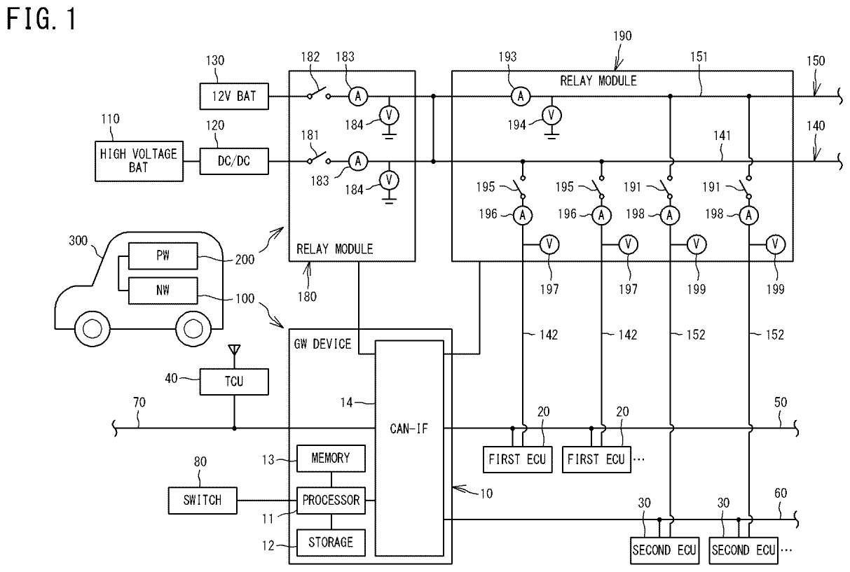

FIG. 1 is a network connection diagram showing an example of an overall configuration of an in-vehicle communication system 100 and a power supply system 200 installed in a vehicle 300.

As shown in FIG. 1, the in-vehicle communication system 100 and the power supply system 200 are installed in the vehicle 300. The in-vehicle communication system 100 includes a gateway device (hereinafter also referred to as “GW device”) 10, a plurality of types of ECUs 20, 30 having different start-up conditions, and a TCU (Telematics Control Unit) 40.

The in-vehicle communication system 100 of the present embodiment includes a CAN (Controller Area Network) having a bus-type network topology, and the CAN network includes a plurality of CAN buses 50, 60, 70 connected to the GW device 10.

A plurality of ECUs 20 are connected to the CAN bus 50. A plurality of ECUs 30 are connected to the CAN bus 60. Each of the ECUs 20, 30 includes a CAN interface capable of CAN communication.

The TCU 40 is connected to the CAN bus 70. The TCU 40 includes a CAN interface capable of CAN communication, and a wireless interface for outside-vehicle communication.

As a wireless interface protocol, for example, at least one of LTE (Long Term Evolution), 5G (fifth-generation mobile network system), DSRC (Dedicated Short-Range Communications), Wi-Fi (registered trademark), and the like can be adopted.

A communication protocol capable of periodically or nonperiodically transmitting/receiving messages is adopted for the GW device 10, the plurality of ECUs 20, 30, and the TCU 40. The communication protocol is CAN or CAN FD (CAN with Flexible Data Rate), for example.

The GW device 10 has a relay function between the CAN buses 50, 60, 70. That is, the GW device 10 can relay a CAN message transmitted to any one of the CAN buses 50, 60, 70, to another CAN bus.

The plurality of ECUs 20, 30 belong to systems, such as a control system relating to an engine and a transmission, a body system relating to headlights and power windows, and an information system relating to car navigation and multimedia, and are disposed in respective parts of the vehicle.

The plurality of ECUs 20, 30 individually control actuators of the parts of the vehicle, and generate measurement data (temperature, speed, acceleration, digital image, etc.) based on reception signals from the sensors at the parts of the vehicle.

The plurality of ECUs 20, 30 include “first ECU 20” and “second ECU 30” having different start-up conditions, as follows.

The first ECU 20 is an ECU that does not have a network management function (hereinafter referred to as “NM function”). Hereinafter, the first ECU 20 is also referred to as “power supply start-up ECU”. The operation state of the first ECU 20 can take two states, “operating” (ON) and “stop” (OFF), according to whether or not power is supplied from the power supply system 200.

The second ECU 30 is an ECU having an NM function. Hereinafter, the second ECU 30 is also referred to as “communication start-up ECU”. The operation state of the second ECU 30 can take two states, “operating” (ON) and “standby” (sleep), according to an instruction of an NM message.

The plurality of ECUs 20, 30 have a function of providing the user of the vehicle with services. One service can be provided by one or a plurality of ECUs 20, 30.

For example, a “manned driving” service described later is provided by an ECU group including at least one first ECU 20. A “smart entry” service described later is provided by an ECU group including at least one second ECU 30.

### Overall Configuration of Power Supply System

As shown in FIG. 1, the power supply system 200 includes a high voltage battery 110, a DC/DC converter 120, an auxiliary battery 130, a first power supply line 140, and a second power supply line 150.

The high voltage battery 110 is a battery having an output voltage of 400 V, for example, and is used for vehicle travel control and air-conditioning control. The DC/DC converter 120 is connected to the high voltage battery 110, and steps down the output voltage of the high voltage battery 110 to 12 V. The auxiliary battery 130 is a battery having an output voltage of 12 V, for example, and is used for driving an auxiliary machine in the vehicle 300.

The first power supply line 140 is a line for supplying power to the first ECU 20.

The first power supply line 140 includes: a power line 141 that is a trunk line connected to the DC/DC converter 120; and a plurality of power lines 142 that are branch lines branching from the power line 141. The first ECUs 20 are connected to the branch destinations of the respective power lines 142.

The second power supply line 150 is a line for supplying power to the second ECU 30.

The second power supply line 150 includes: a power line 151 that is a trunk line connected to the auxiliary battery 130; and a plurality of power lines 152 that are branch lines branching from the power line 151. The second ECUs 30 are connected to the branch destinations of the respective branch lines 152.

The power supply system 200 includes a pair of relay modules 180, 190 that are disposed in intermediate portions of the power lines 141, 151, and perform relay switching.

The power lines 141, 151 are electrically conductive between the relay modules 180, 190. Therefore, the output power of the DC/DC converter 120 is used not only for power supply to the first ECUs 20 but also for charging the auxiliary battery 130.

The relay module 180 on the upstream side (left side in FIG. 1) includes: relays 181, 182 that turn on or off the power lines 141, 151; current sensors 183 that measure the current values of the power lines 141, 151; and voltage sensors 184 that measure the voltage values of the power lines 141, 151.

The relay module 190 on the downstream side (right side in FIG. 1) includes a current sensor 193 that measures the current value of the power line 151, and a voltage sensor 194 that measures the voltage value of the power line 151.

The relay 181 located halfway through the power line 141 is a relay that is controlled to be normally OFF. The relay 182 located halfway through the power line 151 is a relay that is controlled to be normally ON.

The downstream relay module 190 further includes: relays 195 that turn on or off the power lines 142 that supply power to the first ECUs 20; current sensors 196 that measure the current values of the power lines 142; and voltage sensors 197 that measure the voltage values of the power lines 142.

The downstream relay module 190 further includes: relays 191 that are controlled to be normally ON, and turn on or off the power lines 152 that supply power to the second ECUs 30; current sensors 198 that measure the current values of the power lines 152; and voltage sensors 199 that measure the voltage values of the power lines 152.

The relay module 190 can open and close the relays 191, 195 individually according to a user's switch operation, an NM message, etc.

In FIG. 1, only the first ECUs 20 are connected to the first power supply line 140. However, the second ECUs 30 having the NM function may be connected to the first power supply line 140, and the relay 181 or the relay 182 may be set to be normally ON to constantly supply power to the second ECUs 30.

Meanwhile, the first ECUs 20 are not connected to the second power supply line 150. This is because the first ECUs 20, which do not have a sleep function based on communication, should not be connected to the second power supply line 150 that constantly supplies power.

### Internal Configuration of Gateway Device

As shown in FIG. 1, the GW device 10 includes a processor 11, a storage 12, a memory 13, and a communication interface 14.

The processor 11 is an integrated circuit composed of one or a plurality of CPUs (Central Processing Units), for example.

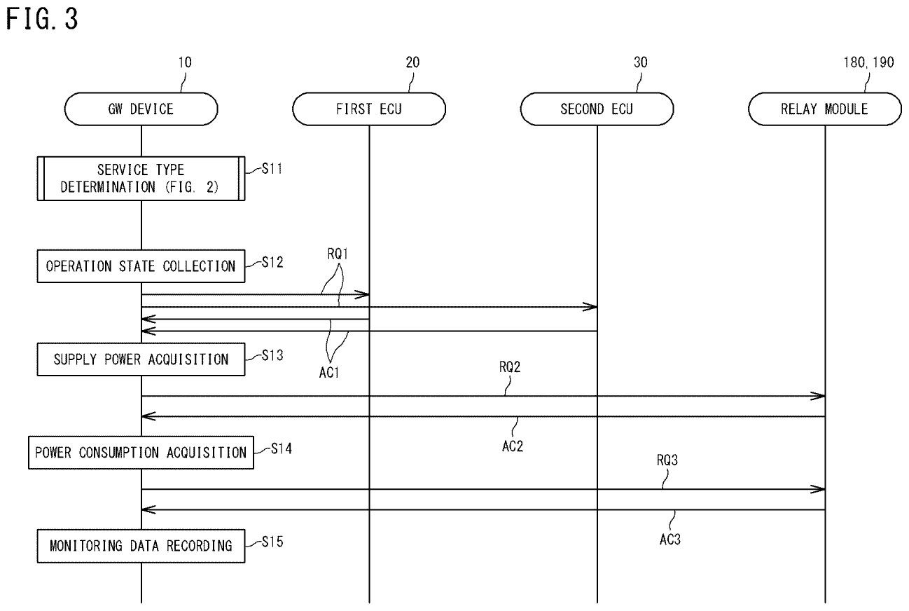

The processor 11 can read computer programs stored in the storage 12 onto the memory 13 and execute the programs. The computer programs include a program for realizing a power monitoring process (FIG. 3) described later.

The processor 11 may be an ASIC (Application Specific Integrated Circuit), an FPGA (Field Programmable Gate Array), or the like. In this case, the ASIC or the FPGA is configured to be able to execute functions realized by the computer programs.

The storage 12 is, for example, a non-volatile memory such as a flash memory, a hard disk, or a ROM (Read Only Memory). The computer programs to be executed by the processor 11 and data required for the execution are stored in the storage 12.

The memory 13 is a volatile memory, and a semiconductor memory such as an SRAM (Static Random Access Memory) or a DRAM (Dynamic Random Access Memory) can be adopted.

The communication interface 14 is a communication module according to CAN. The communication interface 14 has a plurality of CAN ports, and the CAN buses 50, 60, 70 are connected to the respective CAN ports.

The processor 11 has a CAN message relay function. Specifically, the processor 11 determines to which one of the CAN buses 50, 60, 70 a received message should be relayed, based on a CAN ID included in the received message.

The processor 11 receives a CAN message addressed thereto, and uses data included in the message for predetermined processes including the power monitoring process (FIG. 3) described later.

The processor 11 generates data to be provided to external devices such as a server of a vehicle manufacturer and a mobile terminal of the user, and outputs, to the communication interface 14, a CAN message that includes the data and is addressed to the TCU 40.

The relay modules 180, 190 are also connected to the CAN ports of the communication interface 14. Therefore, the processor 11 can perform CAN communication with the relay modules 180, 190 as well.

A switch 80 is connected to the processor 11 via a predetermined signal line. The switch 80 is a switch for changing the status of the power supply system 200, and is a push switch, for example. The switch operation causes the state of the power supply system 200 to transition as follows, for example.
Transition 1: switch operation at +B→power supply status transitions to ACC
Transition 2: switch operation at ACC→power supply status transitions to IG
Transition 3: switch operation at IG→power supply status transitions to +B

The processor 11 performs power supply control to change the status of the power supply system 200 according to the switch operation.

Specifically, upon detecting a switch operation at +B, the processor 11 switches opening and closing of the relays 181, 182, 191, 195 so as to achieve Transition 1.

Likewise, upon detecting a switch operation at ACC, the processor 11 switches opening and closing of the relays 181, 182, 191, 195 so as to achieve Transition 2.

Likewise, upon detecting a switch operation at IG, the processor 11 switches opening and closing of the relays 181, 182, 191, 195 so as to achieve Transition 3.

### Service Type Determination Process

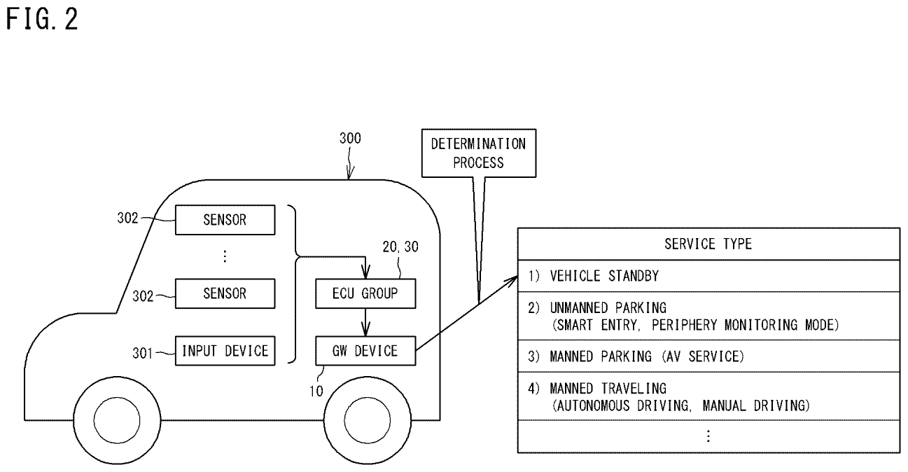

FIG. 2 illustrates an example of a service type determination process.

As shown in FIG. 2, the vehicle 300 includes an input device 301 that wirelessly receives an instruction from the user (owner of the vehicle 300, etc.), and various sensors 302 that detect the state of the compartment of the vehicle 300, the state around the vehicle 300, and objects.

The input device 301 is, for example, a touch sensor that is attached to a display disposed on a dashboard. In another example, the input device 301 is a switch disposed on a dashboard, a steering, etc., of the vehicle.

The sensors 302 are, for example, a camera, a radar, a LiDAR, a motion sensor, a seating sensor, a shift position sensor, an oil pressure sensor, a temperature sensor, a vehicle speed sensor, an engine (or motor) rotation speed sensor, an accel pedal stroke sensor, a brake pedal stroke sensor, a steering angle sensor, and the like.

The GW device 10 of the present embodiment has a partial network function. This function divides the network into PNCs (Partial Network Clusters) for each service type, causes the second ECU 30 belonging to a PNC related to a service to wake up, and causes the second ECUs 30 belonging to the other PNCs to sleep.

As shown in FIG. 2, the types of services that the vehicle 300 provides to the user include, for example, “vehicle standby”, “unmanned parking”, “manned parking”, “manned traveling”, etc.

The “vehicle standby” is a service in which the vehicle 300 is caused to stand by in the parked state so that the vehicle 300 can respond to a request of the user for a service any time by causing the second ECU 30 to stand by in the communicable state. In the standby state, the second ECU 30 operates the CAN interface and stops the processor to perform power-saving control.

In the standby state of the smart entry ECU, the body ECU, or the like among the second ECUs 30, a function for monitoring the state of hardware or the state around the vehicle is intermittently operated in addition to monitoring the CAN interface.

The “unmanned parking” is a service provided to the vehicle 300 being unmanned and parked.

A predetermined ECU that performs the unmanned parking service among the second ECUs 30 receives an unmanned parking execution instruction from the input device 301, and transmits, to the GW device 10, an NM message in which a PNC corresponding to unmanned parking is designated.

Moreover, when the predetermined ECU that performs the unmanned parking service among the second ECUs 30 has received the unmanned parking execution instruction from the input device 301, the ECU may transmit a CAN message notifying the reception of the instruction to the GW device 10.

Based on the PNC in the received NM message, the GW device 10 determines CAN buses 50, 60 including the ECUs that need to be started up, and transmits an NM message to the CAN buses 50, 60. The second ECU 30, which has received the NM message, wakes up if the designated PNC matches its own PNC, and remains sleeping if there is no match.

Based on the NM message including the PNC transmitted from the second ECU 30 or the CAN message indicating the unmanned parking execution instruction transmitted from the second ECU 30, the GW device 10 causes transition to the power supply status corresponding to the unmanned parking, and the first ECU 20 corresponding to the unmanned parking also enters the operating state.

Thus, the first ECU 20 and the second ECU 30 corresponding to the unmanned parking enter the operating states, and the service type transitions to the unmanned parking.

The unmanned parking service includes, for example, smart entry, periphery monitoring mode, etc.

The smart entry is performed by a door lock control ECU unlocking the door, based on user face recognition by an outside-vehicle image processing ECU and on door handle touch detection by the sensor 302.

The periphery monitoring mode is performed by transmitting an image capturing instruction to an ECU that controls a camera capable of capturing a moving image outside the vehicle, based on detection of an approaching person by the outside-vehicle image processing ECU.

The “manned parking” is a service provided to the vehicle 300 being manned and parked.

Upon receiving a manned parking execution instruction from the input device 301, the GW device 10 transmits, to the CAN buses 50, 60, an NM message in which a PNC corresponding to the manned parking is designated.

The second ECU 30, which has received the NM message, wakes up if the designated PNC matches its own PNC, and remains sleeping if there is no match.

Based on the NM message including the PNC transmitted from the second ECU 30 or the CAN message indicating the manned parking execution instruction transmitted from the second ECU 30, the GW device 10 causes transition to the power supply status corresponding to the manned parking, and the first ECU 20 corresponding to the manned parking also enters the operating state.

Therefore, the first ECU 20 and the second ECU 30 corresponding to the manned parking enter the operating states, and the service type transitions to the manned parking.

The manned parking service includes, for example, an audio/visual (AV) service, etc. The AV service is executed by a multimedia ECU.

In the AV service, contents such as music, movies, etc., are reproduced by the multimedia ECU. For example, the AV service is started when seating is detected by a seating sensor provided in a seat.

The “manned traveling” is a service provided to the vehicle 300 being manned and traveling.

The manned traveling service includes, for example, an adaptive cruise control service that is a kind of autonomous driving. The adaptive cruise is started when, for example, shifting of a gear lever from P range to D range is detected by a shift position sensor.

When shifting of the gear lever to the D range has been detected, the GW device 10 transmits, to the CAN buses 50, 60, a service instruction addressed to the ECUs 20, 30 related to the adaptive cruise. Thus, the service type transitions to the adaptive cruise.

The adaptive cruise is a service in which the steering angle and the vehicle speed of the vehicle 300 are controlled so as not to cross a lane while maintaining an inter-vehicle distance from a preceding vehicle. The adaptive cruise is realized by cooperation of the following ECUs, for example.
A ranging ECU that detects an inter-vehicle distance from a LiDAR or a camera
An image processing ECU that detects a lane from an image, ahead of the vehicle, captured by a camera
A steering ECU that controls the steering angle or the actual steering angle
A drive-related ECU that controls motors such as an engine, an electric motor, etc.

### Details of Power Monitoring Process

FIG. 3 is a sequential diagram showing an example of a power monitoring process performed by the GW device 10.

In the following description, each of processes that are executed by the GW device 10 is executed by the processor 11 of the GW device 10 in actuality.

As shown in FIG. 3, the GW device 10 executes “service type determination (FIG. 2)” in the vehicle 300 (step S11). The details of this determination process are as described above.

Next, the GW device 10 executes “operation state collection” (step S12). The operation state is the operation state (operating, standby, or stop) of each of the ECUs 20, 30.

This process is performed by causing the communication interface 14 to broadcast an operation state request message RQ1 to the CAN buses 50, 60, and receiving a response message AC1 from each of the ECUs 20, 30. Therefore, the communication interface 14 functions as an acquisition unit for the operation states of the ECUs 20, 30.

The GW device 10 determines that the first ECU 20 is operating if the response message AC1 can be received from the first ECU 20, and judges that the first ECU 20 is stopped if the message AC1 cannot be received.

Meanwhile, as for the second ECU 30, the GW device 10 determines the operation state of the second ECU 30, based on the PNC transmitted from the second ECU 30.

Next, the GW device 10 executes “supply power acquisition” (step S13).

This process is performed by causing the communication interface 14 to transmit a supply power request message RQ2 to the relay modules 180, 190, and receiving, from the relay modules 180, 190, a response message AC2 including the supply power (e.g., supply current and voltage) at the present time outputted from the DC/DC converter 120 and the auxiliary battery 130. Therefore, the communication interface 14 functions as an acquisition unit for the supply power.

Next, the GW device 10 executes “power consumption acquisition” (step S14).

This process is performed by causing the second interface 14 to transmit a power consumption request message RQ3 to the relay modules 180, 190, and receiving, from the relay modules 180, 190, a response message AC3 including the power consumption (e.g., current consumption and voltage consumption) at the present time to be outputted to each of the ECUs 20, 30. Therefore, the second interface 14 functions as an acquisition unit for the power consumption.

As for the first ECU 20 that is stopped, it is obvious that the power consumption is zero, and therefore, transmission of the request message RQ3 may be omitted.

Next, the GW device 10 executes “monitoring data recording” (step S15). This process is storing the supply power acquired in step S13 and the power consumption acquired in step S14 into the storage 12 in a predetermined data format. The GW device 10 transmits the monitoring data stored in the storage 12 to the server of the vehicle manufacturer via the TCU 40, for example.

### Data Table of Monitoring Data

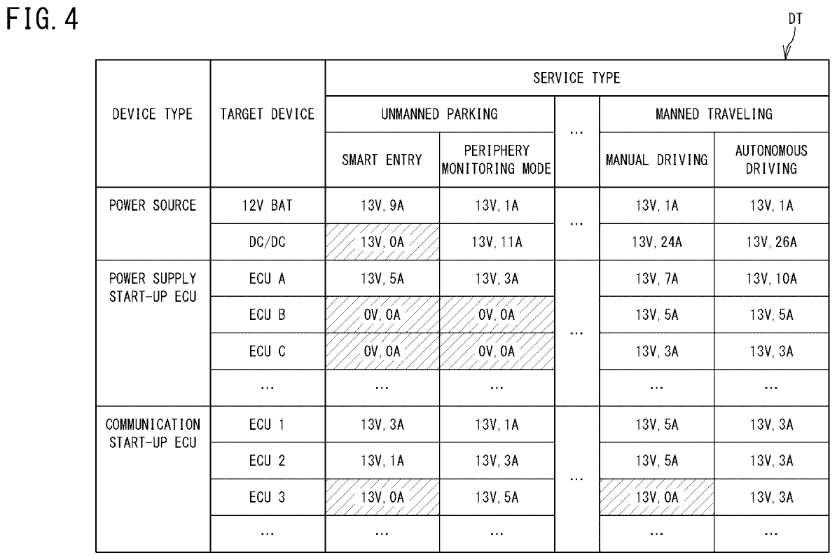

FIG. 4 illustrates a data table DT showing an example of monitoring data.

As shown in FIG. 4, columns of the data table DT include “device type”, “target device”, and “service type”.

Under the column for device type, “power source”, “power supply start-up ECU” (identical to the first ECU 20), and “communication start-up ECU” (identical to the second ECU 30) are listed.

Under the column for target device, names or identification information of in-vehicle devices whose powers (current values and voltage values) are to be monitored, are listed.

The names of target devices include, for example, “12V BAT” (identical to the auxiliary battery 130) and “DCDC” (identical to the DC/DC converter 120). The identification information of target devices includes ECU identification information (ECU A, ECU B, ECU C, etc.).

Under the column for service type, the names of service types at the power acquisition time are listed. On the data table DT shown in FIG. 4, as an example of service types, “smart entry” and “periphery monitoring mode” that belong to “unmanned parking”, and “manual driving” and “autonomous driving” that belong to “manned traveling” are shown.

In the data table DT shown in FIG. 4, cells with diagonal hatching indicate that the in-vehicle devices corresponding to the cells are in the stop (OFF) states.

### Effects of Power Monitoring Process

As shown in FIG. 4, the data table DT created by the GW device 10 includes the supply powers of the power supplies 120, 130 and the power consumptions of the ECUs 20, 30 for each service type being executed in the vehicle 300.

Therefore, the engineers of the vehicle manufacturer can judge, for each service type, whether or not power demand and supply in the system are appropriate, based on the power values included in the data table DT.

Moreover, the data table DT created by the GW device 10 includes the operation states (e.g., stop or operating) of the plurality of ECUs 20, 30 for each service type being executed in the vehicle 300.

Therefore, the engineers of the vehicle manufacturer can judge, for each service type, whether or not appropriate ECUs are operating, based on the operation states included in the data table DT.

When many data tables DT for a predetermined period of time have been obtained, statistical analysis may be performed.

For example, when data tables DT have been collected from a plurality of vehicles 300 over a predetermined period (e.g., 1 year), it is possible to judge, for each service type, ECUs 20, 30 that are likely to cause power abnormality and ECUs 20, 30 on which power reduction can be executed, based on a statistic (such as an average or a median) of the powers included in the collected data tables DT.

Moreover, an appropriate range of power consumption of the ECUs 20, 30 for each service type may be specified based on the above statistic, and the specified appropriate range may be notified from the server to the GW device 10 via the TCU 40.

This allows the GW device 10 to determine, for each service type, whether or not the electric behaviors of the ECUs 20, 30 are normal, based on whether or not the power consumption of the ECUs 20, 30 executing a predetermined service type is within the appropriate range. Upon detecting an abnormality, the GW device 10 may notify at least one of the server and the mobile terminal of the user of occurrence of the abnormality via the TCU 40.

In the above embodiment, the battery temperature of a thermal management system, the temperature of a drive system, the temperature of an air conditioner, and the operating state of a cooling/heating system, which are installed in the vehicle 300, may be collected as well, and the relationship with the electric behaviors may be statistically analyzed and shown on the data table DT.

### Modifications

The embodiment disclosed herein is merely illustrative and not restrictive in all aspects. The scope of the present disclosure is defined by the scope of the claims rather than the embodiment described above, and is intended to include meaning equivalent to the scope of the claims and all modifications within the scope.

In the above embodiment, although the in-vehicle communication system 100 is implemented as a CAN network, the in-vehicle communication system 100 may be implemented as an Ethernet network (Ethernet: registered trademark).

The in-vehicle communication system 100 may include both the CAN network and the Ethernet network. In this case, the GW device 10 may have a protocol conversion function between the CAN and the Ethernet.

Moreover, the communication protocol of the in-vehicle communication system 100 may be CAN FD (CAN with Flexible Data Rate), FlexRay (registered trademark), MOST (Media Oriented System Transport) (registered trademark), LIN (Local Interconnect Network), CXPI (Clock Extension Peripheral Interface) (registered trademark), or the like.

1. A vehicle power monitoring device belonging to an in-vehicle communication system, comprising:
an acquisition unit configured to acquire supply power from a power supply system, and power consumptions of a plurality of ECUs belonging to the in-vehicle communication system; and
a processor configured to record the supply power and the power consumptions that have been acquired, wherein
the processor determines a service type being executed in a vehicle, and causes the acquisition unit to acquire the supply power and the power consumptions in the determined service type.

2. The vehicle power monitoring device according to claim 1, wherein the processor collects operation states of the plurality of ECUs in the determined service type, and records the collected operation states.

3. The vehicle power monitoring device according to claim 1, wherein the plurality of ECUs include:
a power-supply start-up ECU not having a network management function; and
a communication start-up ECU having the function.

4. The vehicle power monitoring device according to claim 3, wherein the service type includes at least one of:
vehicle standby in which the vehicle is caused to stand by in a parked state so that the vehicle can always respond to a request of a user for a service;
unmanned parking that is provided to the vehicle being unmanned and parked;
manned parking that is provided to the vehicle being manned and parked; and
manned traveling that is provided to the vehicle being manned and traveling.

5. A vehicle power monitoring method executed by a power monitoring device belonging to an in-vehicle communication system, the method comprising:
determining a service type being executed in a vehicle;
acquiring supply power from a power supply system in the determined service type;
acquiring power consumptions of a plurality of ECUs belonging to the in-vehicle communication system, in the determined service type; and
recording the supply power and the power consumptions that have been acquired.

6. A non-transitory computer-readable storage medium in which a computer program that causes a computer to function as a power monitoring device belonging to an in-vehicle communication system is recorded,
the computer program causing the computer to function as:
an acquisition unit configured to acquire supply power from a power supply system, and power consumptions of a plurality of ECUs belonging to the in-vehicle communication system; and
a processor configured to record the supply power and the power consumptions that have been acquired, wherein
the processor determines a service type being executed in a vehicle, and causes the acquisition unit to acquire the supply power and the power consumptions in the determined service type.
